(19) United States
(12) Patent Application Publication
(10) Pub. No.: US 2009/0194733 A1
(43) Pub. Date: Aug. 6, 2009

(54) SUPERPARAMAGNETIC TRANSITION METAL IRON OXYGEN NANOPARTICLES

(75) Inventors: Douglas L. Schulz, Moorhead, MN (US); Robert A. Sailer, West Fargo, ND (US); Anthony N. Caruso, Peculiar, MO (US)

Correspondence Address: FOLEY & LARDNER LLP, 777 EAST WISCONSIN AVENUE, MILWAUKEE, WI, 53202-5306, US

(73) Assignee: NDSU Research Foundation

(21) Appl. No.: 12/205,641

(22) Filed: Sep. 5, 2008

Related U.S. Application Data
(63) Continuation of application No. PCT/US07/06164, filed on Mar. 12, 2007.
(60) Provisional application No. 60/781,859, filed on Mar. 13, 2006.
(60) Provisional application No. 60/781,813, filed on Mar. 13, 2006.

(51) Int. Cl. C01G 49/08

(52) U.S. Cl. 252/62.56; 977/775

(57) ABSTRACT

Thermal treatment of transition metal ferrite nanoparticles at moderate temperatures provides materials with desirable magnetic properties. AₓFe₃₋ₓO₄ nanoparticles, e.g., with metal ratio from x=0.4 to 1.0, can be prepared according to standard solution micelle techniques. While the materials produced by micelle synthesis, such as CoFe₂O₄ nanoparticles, appeared to be comprised of mainly the magnetite phase (e.g., CoFe₂O₄) by x-ray diffraction, multiphase materials were observed after the transition metal ferrite nanoparticles were subjected to thermal treatment under nitrogen. Magnetization as a function of applied field and temperature reveal variations in saturation magnetization, coercivity, blocking temperature and Verwey transition temperature dependence as a function of composition. Extremely high saturation magnetization with low coercivity can be achieved with such compositions.

### CROSS REFERENCE TO RELATED APPLICATIONS

This application claims priority under 35 U.S.C. § 119(e) of U.S. Provisional Application Ser. Nos. 60/781,813 and 60/781,859 (both of which were filed on Mar. 13, 2006), and International Application PCT/US07/06164 (filed on Mar. 12, 2007), the disclosures of which are herein incorporated by reference in their entireties.

### GOVERNMENT RIGHTS STATEMENT

The U.S. Government has a paid-up license in this invention and the certain other rights in the invention as a result of support for this work for by Defense Microelectronics Activity (DMEA) under agreement DMEA 90-02-2-0218 and the National Science Foundation through ND EPSCoR grants EPS-0447679 and EP-0132289.

### BACKGROUND

Superparamagnetic nanoparticles are multifunctional materials where size provides utility for both magnetic exchange and use. The interest in such nanoparticles provides strong impetus toward understanding and controlling their phase, composition and size as relates to the basic magnetic response. Transition metal oxide nanoparticles are simple and inexpensive to fabricate in large quantities with uniform physical and magnetic properties and can be encapsulated, functionalized or left naked as an ambient stable oxide.

Many basic studies of transition metal oxide nanoparticles have been completed that relate magnetic response—coercivity (H_{c}), saturation magnetization (Mₛ), relaxation time, permeability and/or blocking (T_{B}), Verwey (T_{V}) or Curie (T_{C}) transition—to raw diameter, shape or crystalline anisotropy, composition, coordination, density, exchange interaction, phase or structure, surface effects, spin-orbit coupling and/or system temperature. Such studies have provided many gross trends: (1) decreasing particle size leads to decreased H_{c} and T_{c}; (2) surface spin disorder leads to surface anisotropy with increased H_{c}; (3) greater spin-orbit coupling leads to increased exchange anisotropy that tends to increase H_{c}. For cobalt ferrites specifically, the canonical role of cobalt has been to increase H_{c} due to an increased anisotropy. A series of compositions and phases of nanoparticles containing chromium, manganese, iron, cobalt, and/or nickel with iron and oxygen with magnetic responses over a threshold that do not fit with present models for Mₛ and/or H_{c} (relative to canonical transition metal oxides) are described herein.

### SUMMARY

The present application relates to transition metal oxygen nanoparticles. The nanoparticles may have desirable magnetic properties such as a high saturation magnetization coupled with low coercivity. The nanoparticles may be produced from AₓFe₃₋ₓO_{4-y} nanoparticles (e.g., where is from x=0.4 to 1.0), where the “A” element is a transition metal element, such as chromium, manganese, cobalt, and/or nickel. The nanoparticles may have a saturation magnetization of at least about 80 emu/g and/or a coercivity (H_{c}) of no more than about 75 Oe. In some embodiments, the nanoparticles may have a coercivity (H_{c}) of no more than about 65 Oe, desirably, no more than about 55 Oe and, in some instances, no more than about 10 Oe. In certain embodiments, the nanoparticles may have a saturation magnetization of at least about 100 emu/g.

Thermal treatment of the present transition metal ferrite nanoparticles at moderate temperatures (e.g., 500° C. to 850° C.) can provide materials with unanticipated and desirable magnetic properties. AₓFe₃₋ₓO_{4-y} nanoparticles, e.g., with metal ratio from x=0.4 to 1.0, can be prepared according to standard solution micelle syntheses. While the materials produced by solution micelle synthesis, such as CoFe₂O₄ nanoparticles, appeared to be comprised of mainly the magnetite phase (e.g., CoFe₂O₄) by x-ray diffraction, multiphase materials (e.g., including α-Fe and/or zero valent CoFe+CoFe₂O₄) were observed after the transition metal ferrite nanoparticles were subjected to thermal treatment under nitrogen. Magnetization as a function of applied field and temperature reveal variations in saturation magnetization, coercivity, blocking temperature and Verwey transition temperature dependence as a function of composition. Extremely high saturation magnetization (e.g., 180 emu/g) with low coercivity (30 Oe or lower) can be achieved with the present compositions. Such properties deviate drastically from those commonly observed for bulk values of the phases, which make up the material. While not limiting the present application, it is believed that such differences in properties may be attributed to the reduced surface spin disorder and low anisotropy energy induced as a function of the fabrication procedure.

One embodiment relates to superparamagnetic transition metal, iron and oxygen nanoparticles having a saturation magnetization of at least about 100 emu/g, where the transition metal may comprise chromium, manganese, iron, cobalt, and/or nickel.

Another embodiment relates to transition metal iron oxygen nanoparticles formed by a process which comprises: a) forming ĀₓFe₃₋ₓO₄ particles via micellular synthesis; and b) heating the ĀₓFe₃₋ₓO₄ particles in an oven at about 450° C. to 850° C. Ā may be selected from the group consisting of chromium, manganese, cobalt, and/or nickel.

Yet another embodiment relates to superparamagnetic transition metal, iron and oxygen nanoparticles having a saturation magnetization of at least about 80 emu/g and a coercivity (H_{c}) of no more than about 75 Oe.

### FIGURE CAPTIONS

FIG. 1. X-ray diffraction results for the particles 6N5, 6N8, 6O5 and 6O8. The markers at the bottom of the figure indicate individual phases; ▴ spinel ferrite Fe₃O₄, CoFe₂O₃ or Fe₂O₃; ▾ Wairauite CoFe; ▪ non-spinel Hematite Fe₂O₃; and ♦ iron α-Fe.

FIG. 2. Magnetization as a function of applied field on the particle system 6N5. The black solid line is for measurements completed at 300 K, while the red dashed curve was completed at 5 K. The inset demonstrates the low coercive and remnant values despite anisotropy inducing cobalt.

FIG. 3. Field cooled and non-field cooled magnetization as a function of temperature on the particle systems 6N5 and 6N7 with the Verwey and blocking temperature identified.

FIG. 4. FWHM of the 35.4° peak used for Scherrer analysis of the 6N5 treated particles.

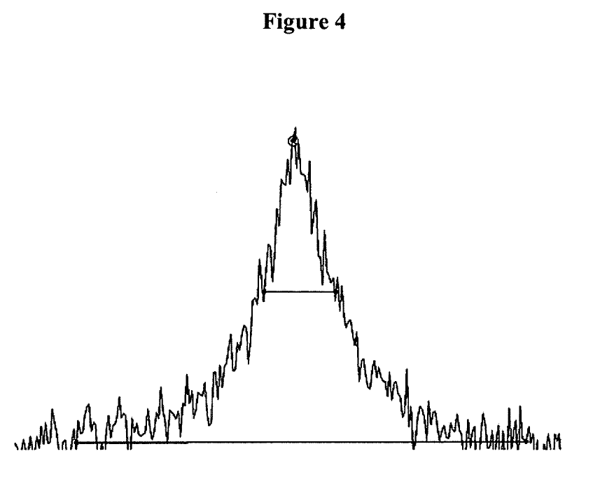

FIG. 5. TEM image of the as synthesized Co_{0.6}Fe_{2.4}O₄ particles demonstrating the spherical shape and uniformity.

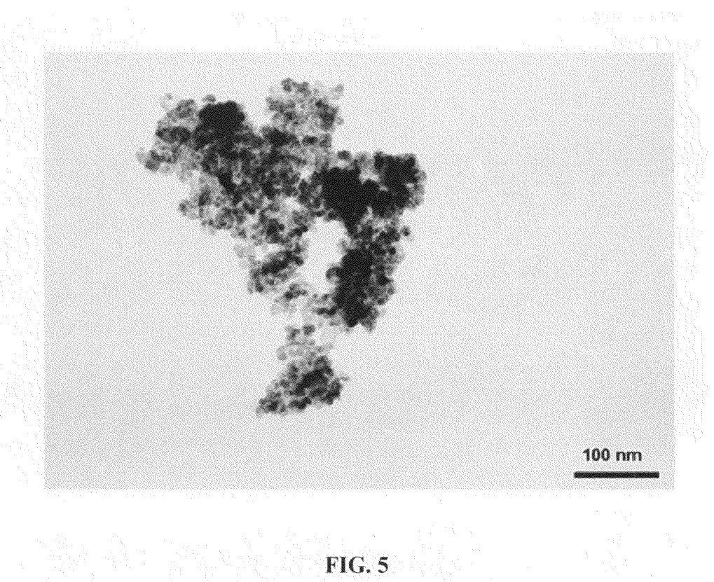

### EXPERIMENT

CoₓFe₃₋ₓO₄ nanoparticles with x=0.6, 0.8 and 1.0 were prepared according to a micelle approach previously reported by Li et al., J. Alloys. Compounds, 349, 264 (2003), the disclosure of which is herein incorporated by reference. In brief, targeted amounts of high purity (i.e., 99.998+%) iron nitrate hydrate and cobalt nitrate hydrate were dissolved in 18 MΩ deionized to give an total metals molarity of between 0.01 and 0.02 mol/L. To this solution was added sodium dodecylsulfate (SDS) to give a concentration of between 0.03 and 0/06 mol/L. The mixture was then heated to 50° C. in a water bath. A 6M NaOH solution was warmed to 50° C. and 0.045 mol of this stock solution was added to the reaction mixture yielding a brownish-yellow precipitate. After cooling, the reaction solvent was decanted and the SDS was extracted from the residual cobalt ferrite nanoparticles with acetone in a Soxhlet extractor. These materials were dried in an oven over night at 80° C. and stored in a sealed vial until being subjected to the thermal treatments.

For the thermal treatments, approximately 50 mg aliquots of the CoₓFe₃₋ₓO₄ particles were loaded into alumina crucibles and placed onto a quartz boat and then moved into the center of a three-zone quartz tube Linberg furnace. After the end cap was put into place, the tube was purged with reactant gas (i.e., nitrogen or oxygen) until 10× the volume of the tube had passed over the samples and through the exit oil bubbler. After the flow rate was reduced to a trickle, the samples were subjected to thermal treatment at either 500° C., 600° C., 700° C. or 800° C. with total time of ˜2 hours at maximum temperature followed by a slow cool to ambient temperature. This cooling rate was controlled and for higher temperatures the oven was allowed to cool overnight. For simple naming, the thermal treated particles are herein be referred to by the designation “xGT”, where x is the cobalt stoichiometry (e.g., x=6 refers to Co_{0.6}Fe_{3.4}O₄, x=10 refers to CoFe₃O₄), G the background gas during reduction (N—nitrogen; O—oxygen) and T the temperature during thermal treatment (X 100° C.) so “6N5” refers to Co_{0.6}Fe_{2.4}O₄ annealed in nitrogen at 500° C.

Magnetization as a function of temperature (5-400K) and applied field (0-9T) were completed using a Quantum Design physical properties measurement system (PPMS) with the vibrating sample magnetometer (VSM) option, calibrated by a DyO standard. The superconducting magnets were zeroed before each non-field cooled measurement and the VSM frequency was held at 40 Hz. X-ray diffraction (XRD) measurements were performed with a Brukker X-8 diffractometer using Cu Kα for the 2θ range 15-70° with the samples mounted on glass by slurry deposition. The instrumental line broadening was calibrated for use in Scherrer analysis to determine particle diameters. Diluted samples were placed on 300 mesh Formvar coated grids using an eppendorf micropipette and immediately wicked off with filter paper. After allowing the sample to dry, images were obtained using a JEOL 100CX II Transmission Electron Microscope at 100,000× magnification and 80 KeV.

### Results

### Structure and Phase

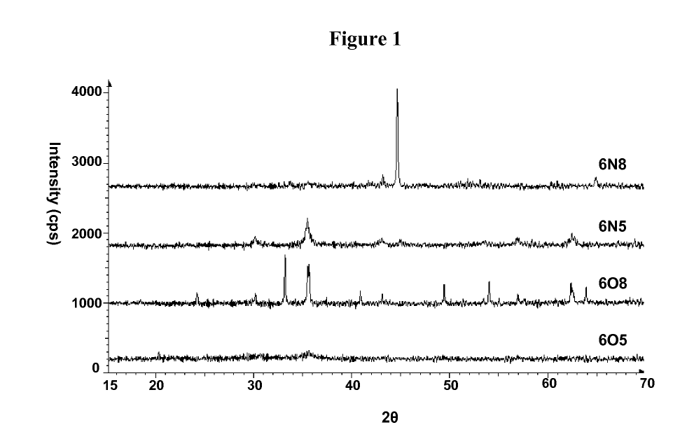

The XRD results for cobalt lean compositions 6N5, 6N8, 6O5 and 6O8 are shown in FIG. 1. The canonical indexes at 2θ=30.1, 35.5, 43.0, 53.5, 57.0 and 62.5° for the spinel ferrites Fe₃O₄, CoFe₂O₄ and Fe₂O₃ are observed weakly for all compositions measured. In the case of 6O5, the particles possess less crystalline phase than all others recorded and a small peak at 20.5° could indicate a trace presence of CoO. For the 6O8 particles, a mixture of the spinel based magnetite and non-spinel based Fe₂O₃ hematite is indicated. The 6N5 particle spectra reveals the presence of a CoFe (Wairauite) phase at 44.9°, that is unique from α-Fe, amongst the spinel ferrite. Lastly, the 6N8 particle composition demonstrates a sharp peak at 44.7° indicating the presence of α-Fe. The intensity and linewidth of this α-Fe strangely suggest the presence of large iron grains, in excess of 100 nm, which does not appear to be the case based on the totality of information available from characterizing the 6N8 particle composition.

### Magnetic Measurements

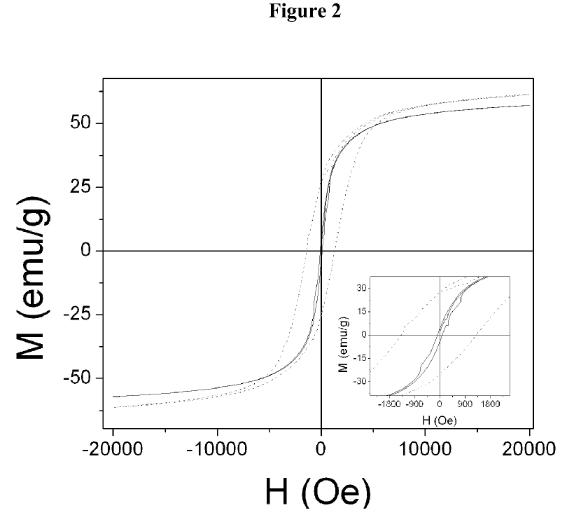

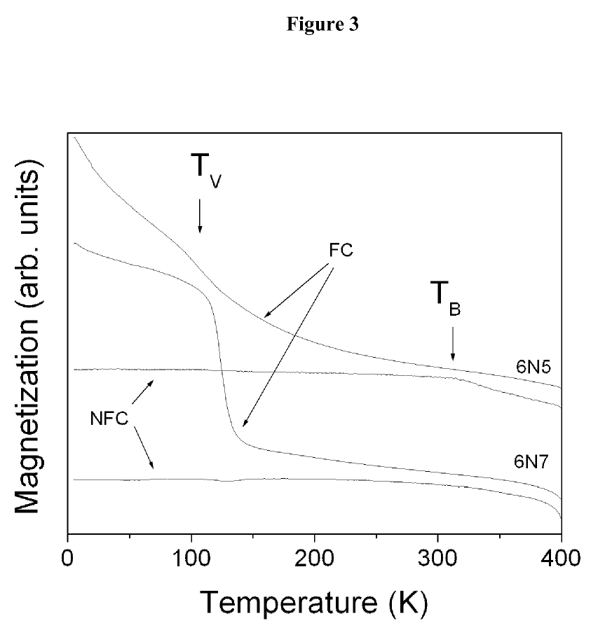

Magnetization as a function of applied field was completed for all composition and treatment parameters, where the values of H_{c}, Mₛ and Mᵣ are compiled in Table 1. The coercivity values range from 4 to 1199 Oe, with remnant magnetization results from 0.03 to 28.7 emu/g, while the saturation values pan an astonishing range from 20 to 159 emu/g. An example curve, to demonstrate the shape of magnetization onset for all of the particles is given by FIG. 2. Magnetization as a function of temperature was completed by both field cooled (FC) and non-field cooled (NFC) to help determine the blocking and Verwey transition points. FIG. 3 shows the M(T) results for the 8N5, 8N8, 8O5 and 8O8 particles, where the field applied during cooling was 2 T.

### Particle Diameter

The diameter of each treated nanoparticle has been calculated (dₘₐₓ) and is compiled in Table 1 as determined by Equation 1, following use of the Langevin function [̂], where k is the Boltzmann constant, T is temperature, (dM/dH) is the slope of the initial (virgin) magnetization curve, ρ is the density and Mₛ is the saturation magnetization. Equation 1

$${d}_{max} = {[ \frac{18 {kT ( d M / d H )}_{H = 0}}{πρ {M}_{s}^{2}} ]}^{1 / 3} \qquad ( 1 )$$

in essence, determines the least upper bound of particle size from the largest magnetization contribution as the initial field is applied; such an analysis may also allow a further determination as to whether small crystallites are buried within other material. Particle diameters were also determined by TEM and through XRD by Scherrer analysis [%]. The comparison between all three methods, using the TEM determination as the standard, yielded dissimilar values. The magnetization calculation (Eqn. 1) underestimated particle size compared to Scherrer analysis which overestimated the diameters. Although it is beyond the scope of this paper to examine why these three methods differ by more than 15 nm, it is noteworthy to ask what can be learned about the physical or magnetic structure of the nanoparticles relative to the assumptions used in the model to generate the diameters. That is, following Langevin theory, we know that when M varies linearly with H, a proportionality can be made to the number of atoms making up each particle; however, as the number of particles is reduced to the superparamagnetic limit, the thermal energy barrier is reduced and the ability to saturate at low fields increases whereby the Langevin constant may exceed ⅓. Hence, smaller than actual diameters calculated from Langevin theory may be crudely used to indicate the presence of superparamagnetic behavior.

### Discussion

### Treatment and Composition Dependence on Nanoparticle Magnetic Response

Many trends in magnetic response with respect to nanoparticle preparation conditions can be extracted from Table 1 and correlated with findings from XRD and particle diameter calculations. One of the most noticeable trends is the tremendous increase in coercivity of all three compositions treated in oxygen at 800 C relative to all other treated particles. We attribute these high H_{c} values to a high uniaxial anisotropy in the standard CoFe₂O₄ spinel phase and these particles are larger overall; however, the coercivity does not significantly decrease with decreased cobalt content as found by others. For all the particles treated in oxygen and those treated in nitrogen at 800 C, a reduced saturation magnetization relative to bulk CoFe₂O₄ is found. This reduction in Mₛ follows arguments regarding surface spin disorder and resulting anisotropy. With respect to results published by Betancourt et al., who found that increased cobalt content leads to significantly decreased Mₛ, we again find conflicting results where saturation magnetization is very consistent between compositions and only different by treatment conditions.

In the case of all compositions treated in nitrogen at 600 C or above, a tremendously high Mₛ value is found relative to all other cobalt ferrite nanoparticle reports and to bulk cobalt ferrite (90 emu/g). Because the saturation values are so high (159 emu/g) relative to bulk cobalt ferrite an explanation involving other phases or exotic mechanisms must occur. Without knowing the exact ionic distribution or degree of inversion of the spinel structure and will be explored in the next section.

### Treatment Implications on Nanoparticle Structure

The XRD results for the 6N5, 6N8, 6O5 and 6O8 compositions indicate a mixture of phases that makeup the nanoparticles. An illustration of the real space nanoparticle makeup may not be drawn soley from the qualitative XRD results, but may be constructed by combining such results with the magnetic measurements and some knowledge of transition metal reduction. It should be noted that above 595 C, the cobalt ferrite particles reduce, similar to Fe₃O₄ reduction to α-Fe observed by others and ascribed to the Hedval mechanism. For the 6N8 nanoparticle system, the XRD results indicate a large presence of α-Fe with some accompanying spinel based ferrite phase. The magnetic measurements on 6N8 indicate an H_{c}=31 Oe, Mᵣ=0.9 emu/g, and Mₛ=159 emu/g. Because of the presence of iron, the small coercivity and the large remnant magnetization, one possible model is that of iron nanoparticles embedded in cobalt ferrite, where the iron particle size is close to or below the superparamagnetic limit.

### Temperature Dependence of the Magnetization

Magnetization as a function of temperature for the 6N5 and 6N8 treated particles as seen in FIG. 3 indicate two transitions in both the FC and NFC measurements. The first intensity reduction at 120 K may be attributed to the Verwey transition as observed by others, with the higher temperature transition indicating the blocking temperature. For the 6N5, which we believe is composed of cobalt ferrite and trace CoFe, the value of T_{B} is on average with other reports.

### Conclusion

A diverse range of magnetic responses have been obtained from a set of cobalt variable ferrite compositions and treatment conditions. The treatment conditions yield multiple phase nanoparticles with both stoichiometric and non-stoichiometric compositions that are phase separated; such a determination has been made through combined x-ray diffraction and magnetization measurements. Of special interest are all those particles treated in nitrogen at or above 600° C., which demonstrate Ms values greater than and Hc values less than bulk cobalt ferrite. The model generated for this system is nanocrystals of iron, whose diameter is at or below the superparamagnetic limit, embedded in a ferrite matrix, with ferrite or oxide residing at the surface. The special emphasis of these particles are due to their application interest wherein refractory superparamagnetic particles with extreme saturation moments and low coercivity, relative to other ferrite nanoparticles, may be produced in large quantities and inexpensively.

### Illustrative Embodiments

The present superparamagnetic transition metal iron oxygen nanoparticles and related methods of producing such particles and/or using such are further exemplified by the following claims and descriptions, which are not intended to limit the scope of the invention disclosed herein.

### Embodiment 1

Superparamagnetic transition metal iron oxygen nanoparticles having a saturation magnetization of at least about 100 emu/g {in some instances ≧125 emu/g and, in others ≧150 emu/g}; wherein the nanoparticles typically include zero valent metal clusters, e.g., α-Fe and/or transition metal/Fe alloy.

The nanoparticles of embodiment 1 wherein said nanoparticles have a coercivity (H_{c}) of no more than about 75 Oe. In some instances ≦50 Oe and, in others ≦35 Oe.

The nanoparticles of embodiment 1 comprising CoₓFe₃₋ₓO₄ particles; wherein x has a value of 0.4 to 1.0.

Superparamagnetic transition metal ferrite nanoparticles having a saturation magnetization of at least about 100 emu/g.

Superparamagnetic transition metal iron oxygen nanoparticles having a saturation magnetization of at least about 100 emu/g and a coercivity (H_{c}) of no more than about 75 Oe.

Superparamagnetic transition metal iron oxygen nanoparticles having a saturation magnetization of at least about 50 emu/g and a coercivity (H_{c}) of no more than about 10 Oe.

Superparamagnetic transition metal iron oxygen nanoparticles having a saturation magnetization of at least about 125 emu/g and a coercivity (H_{c}) of no more than about 35 Oe.

Superparamagnetic transition metal iron oxygen nanoparticles having a saturation magnetization of at least about 150 emu/g and a coercivity (H_{c}) of no more than about 50 Oe.

Superparamagnetic transition metal iron oxygen nanoparticles having a saturation magnetization of at least about 150 emu/g and a coercivity (H_{c}) of no more than about 75 Oe.

Superparamagnetic transition metal iron oxygen nanoparticles having a saturation magnetization of at least about 20 emu/g and a coercivity (H_{c}) of no more than about 5 Oe.

Superparamagnetic transition metal iron oxygen nanoparticles having a saturation magnetization of at least about 150 emu/g; a remnant magnetization of no more than about 5 emu/g; and a coercivity (H_{c}) of no more than about 35 Oe.

Superparamagnetic transition metal iron oxygen nanoparticles having a saturation magnetization of at least about 50 emu/g and a coercivity (H_{c}) of no more than about 20 O.

Superparamagnetic transition metal iron oxygen nanoparticles having a saturation magnetization of at least about 150 emu/g; and a remnant magnetization of no more than about 5 emu/g.

Superparamagnetic transition metal iron oxygen nanoparticles having a saturation magnetization of at least about 100 emu/g; and a remnant magnetization of no more than about 10 emu/g.

Superparamagnetic transition metal iron oxygen nanoparticles having a saturation magnetization of at least about 15 emu/g; and a remnant magnetization of no more than about 0.5 emu/g.

Superparamagnetic transition metal iron oxygen nanoparticles having a saturation magnetization of at least about 20 emu/g; and a remnant magnetization of no more than about 0.1 emu/g.

Superparamagnetic transition metal iron oxygen nanoparticles having a saturation magnetization of at least about 125 emu/g; and a remnant magnetization of no more than about 5 emu/g.

Superparamagnetic transition metal iron oxygen nanoparticles having a saturation magnetization of at least about 50 emu/g; and a remnant magnetization of no more than about 2 emu/g.

### Embodiment 25

Transition metal iron oxygen nanoparticles formed by a process which comprises:

a) forming AₓFe₃₋ₓO₄ particles via micellular synthesis;

b) heating the AₓFe₃₋ₓO₄ particles at about 450° C. to 850° C.
wherein A is a transition metal selected from the group consisting of cobalt, manganese, chromium, and/or nickel. The nanoparticles of embodiment 25 wherein x has a value of 0.4 to 1.0. The nanoparticles of embodiment 25 wherein said nanoparticles are superparamagnetic. The nanoparticles of embodiment 25 wherein the forming operation includes precipitating particles from an aqueous solution which includes iron nitrate hydrate, transition metal nitrate hydrate and sodium dodecylsulfate (SDS). The nanoparticles of embodiment 25 wherein the heating operation includes heating the CoₓFe₃₋ₓO₄ particles at about 550° C. to 850° C. The nanoparticles of embodiment 25 wherein the heating operation includes heating the CoₓFe₃₋ₓO₄ particles for about 1 to 10 hours. The nanoparticles of embodiment 25 wherein the heating operation includes heating the CoₓFe₃₋ₓO₄ particles under a nitrogen atmosphere. The nanoparticles of embodiment 25 wherein x has a value of at least about 0.7. The nanoparticles of embodiment 25 wherein the heating operation includes heating the CoₓFe₃₋ₓO₄ particles at about 750° C. to 850° C. The nanoparticles of embodiment 25 wherein the heating operation includes heating the CoₓFe₃₋ₓO₄ particles in an oven at about 550° C. to 850° C. under a nitrogen atmosphere. Superparamagnetic transition metal iron oxygen nanoparticles having a saturation magnetization of at least about 125 emu/g and a coercivity (H_{c}) of no more than about 50 Oe. The nanoparticles of embodiment 25 wherein the heating operation includes heating the AₓFe₃₋ₓO₄ particles at about 450° C. to 550° C. The nanoparticles of embodiment 25 wherein the heating operation includes heating CoₓFe₃₋ₓO₄ particles under an oxygen atmosphere.

The nanoparticles of embodiment 25 wherein the heating operation includes heating the CoₓFe₃₋ₓO₄ particles at about 450° C. to 550° C. under an oxygen atmosphere. The nanoparticles of embodiment 25 wherein said transition metal iron oxygen nanoparticles have an average crystallite diameter of no more than about 100 nm (as determined by TEM). The nanoparticles of embodiment 25 wherein said transition metal iron oxygen nanoparticles have an average crystallite diameter of no more than about 50 nm (as determined by TEM). The nanoparticles of embodiment 25 wherein said transition metal iron oxygen nanoparticles have an average crystallite diameter of no more than about 50 nm (as determined by XRD). The nanoparticles of embodiment 25 wherein said transition metal iron oxygen nanoparticles have an average crystallite diameter of no more than about 50 nm (as determined by TEM). The nanoparticles of embodiment 25 wherein said transition metal iron oxygen nanoparticles have an average crystallite diameter of no more than about 10 nm (as determined by the Langevin function method). The nanoparticles of embodiment 25 wherein said transition metal iron oxygen nanoparticles have an average crystallite diameter of no more than about 50 nm (as determined by the Langevin function method). The nanoparticles of embodiment 25 comprising a spinel phase. The nanoparticles of embodiment 25 comprising a transition metal ferrite. The nanoparticles of embodiment 25 having crystallite sizes of about 30 to 75 nm (as determined by powder XRD analysis). The nanoparticles of embodiment 25 wherein said transition metal iron oxygen nanoparticles have an Mr/Ms ratio of no more than about 0.1. The nanoparticles of embodiment 25 wherein said transition metal iron oxygen nanoparticles have an Mr/Ms ratio of no more than about 0.01. The nanoparticles of embodiment 25 comprising CoₓFe₃₋ₓO₄ particles; wherein x has a value of 0.4 to 1.0. The nanoparticles of embodiment 25, wherein said nanoparticles include transition metal ferrite nanoparticles.

Such superparamagnetic transition metal iron oxygen nanoparticles having a saturation magnetization of at least about 100 emu/g; a remnant magnetization of no more than about 5 emu/g; and a coercivity (H_{c}) of no more than about 50 Oe.

Superparamagnetic transition metal iron oxygen nanoparticles having a saturation magnetization of at least about 50 emu/g and a coercivity (H_{c}) of no more than about 20 Oe.

Such superparamagnetic transition metal iron oxygen nanoparticles having a saturation magnetization of at least about 50 emu/g; and a remnant magnetization of no more than about 2 emu/g.

Superparamagnetic transition metal iron oxygen nanoparticles having a saturation magnetization of at least about 20 emu/g and a coercivity (H_{c}) of no more than about 5 Oe.

Such superparamagnetic transition metal iron oxygen nanoparticles having a saturation magnetization of at least about 15 emu/g; and a remnant magnetization of no more than about 0.1 emu/g.

Such superparamagnetic transition metal iron oxygen nanoparticles having a saturation magnetization of at least about 20 emu/g; a remnant magnetization of no more than about 0.1 emu/g; and a coercivity (H_{c}) of no more than about 5 Oe.

### Embodiment X

An inorganic/polymer composite material comprising any of the superparamagnetic transition metal iron oxygen nanoparticles described above. The inorganic/polymer composite material of embodiment X further comprising a thermoplastic polymer. The inorganic/polymer composite material of embodiment X further comprising a thermoplastic elastomer.

A flexible coating material comprising the inorganic/polymer composite material of embodiment X.

### Embodiment Q

A composite material comprising any of the superparamagnetic transition metal iron oxygen nanoparticles described above. The composite material of embodiment Q further comprising a ceramic matrix having the nanoparticles embedded therein.

### Embodiment Z

A process of forming transition metal iron oxygen nanoparticles which comprises:

a) forming AₓFe₃₋ₓO₄ particles via micellular synthesis;

b) heating AₓFe₃₋ₓO₄ particles in an oven at about 450° C. to 850° C.;
wherein A is selected from the group consisting of cobalt, manganese, chromium, nickel, iron and mixtures thereof.

The process of embodiment Z wherein the forming operation includes precipitating particles from an aqueous solution formed from a mixture of ingredients which includes iron nitrate hydrate, transition metal nitrate hydrate and sodium dodecylsulfate. The process of embodiment Z further comprising drying the precipitated particles prior to the heating operation. The process of embodiment Z wherein the heating operation includes heating the CoₓFe₃₋ₓO₄ particles in an oven at about 550° C. to 850° C., typically for at least about one hour. The process of embodiment Z wherein the heating operation includes heating the CoₓFe₃₋ₓO₄ particles for about 1 to 10 hours. The process of embodiment Z wherein the heating operation includes heating the CoₓFe₃₋ₓO₄ particles under a nitrogen atmosphere. The process of embodiment Z wherein the heating operation includes heating the CoₓFe₃₋ₓO₄ particles in an oven at about 750° C. to 850° C. The process of embodiment Z wherein the heating operation includes heating the CoₓFe₃₋ₓO₄ particles in an oven at about 595° C. or higher. The process of embodiment Z wherein the heating operation includes heating the CoₓFe₃₋ₓO₄ particles under an oxygen atmosphere. The process of embodiment Z wherein the heating operation includes heating the CoₓFe₃₋ₓO₄ particles at about 450° C. to 550° C. under an oxygen atmosphere.

Superparamagnetic cobalt iron oxygen nanoparticles having a saturation magnetization of at least about 100 emu/g, in some instances ≧125 emu/g and, in others ≧150 emu/g; wherein the nanoparticles typically include zero valent metal clusters, e.g., α-Fe and/or Co/Fe alloy.

Superparamagnetic chromium iron oxygen nanoparticles having a saturation magnetization of at least about 100 emu/g, in some instances ≧125 emu/g and, in others ≧150 emu/g; wherein the nanoparticles typically include zero valent metal clusters, e.g., α-Fe and/or Cr/Fe alloy.

Superparamagnetic nickel iron oxygen nanoparticles having a saturation magnetization of at least about 100 emu/g {in some instances ≧125 emu/g and, in others ≧150 emu/g}; wherein the nanoparticles typically include zero valent metal clusters, e.g., α-Fe and/or Ni/Fe alloy.

Superparamagnetic manganese iron oxygen nanoparticles having a saturation magnetization of at least about 100 emu/g, in some instances ≧125 emu/g and, in others ≧150 emu/g; wherein the nanoparticles typically include zero valent metal clusters, e.g., α-Fe and/or Mn/Fe alloy.

Superparamagnetic iron oxygen nanoparticles having a saturation magnetization of at least about 100 emu/g, in some instances ≧125 emu/g and, in others ≧150 emu/g; wherein the nanoparticles typically include zero valent metal clusters, e.g., . . . , α-Fe.

Superparamagnetic cobalt iron oxygen nanoparticles having a saturation magnetization of at least about 50 emu/g and a coercivity (H_{c}) of no more than about 10 Oe.

Superparamagnetic chromium iron oxygen nanoparticles having a saturation magnetization of at least about 50 emu/g and a coercivity (H_{c}) of no more than about 10 Oe.

Superparamagnetic manganese iron oxygen nanoparticles having a saturation magnetization of at least about 50 emu/g and a coercivity (H_{c}) of no more than about 10 Oe.

Superparamagnetic nickel iron oxygen nanoparticles having a saturation magnetization of at least about 50 emu/g and a coercivity (H_{c}) of no more than about 10 Oe.

Superparamagnetic iron oxygen nanoparticles having a saturation magnetization of at least about 50 emu/g and a coercivity (H_{c}) of no more than about 10 Oe.

Transition metal iron oxygen nanoparticles formed by a process which comprises:

a) forming CoₓFe₃₋ₓO₄ particles via micellular synthesis;

b) heating the CoₓFe₃₋ₓO₄ particles at about 450° C. to 850° C.

Transition metal iron oxygen nanoparticles formed by a process which comprises:

a) forming CrₓFe₃₋ₓO₄ particles via micellular synthesis;

b) heating the CrₓFe₃₋ₓO₄ particles at about 450° C. to 850° C.

Transition metal iron oxygen nanoparticles formed by a process which comprises:

a) forming MnₓFe₃₋ₓO₄ particles via micellular synthesis;

b) heating the MnₓFe₃₋ₓO₄ particles at about 450° C. to 850° C.

Transition metal iron oxygen nanoparticles formed by a process which comprises:

a) forming NiₓFe₃₋ₓO₄ particles via micellular synthesis;

b) heating the NiₓFe₃₋ₓO₄ particles at about 450° C. to 850° C.

Transition metal iron oxygen nanoparticles formed by a process which comprises:

a) forming Fe₃O₄ particles via micellular synthesis;

b) heating the Fe₃O₄ particles at about 450° C. to 850° C.

TABLE 1
Values of remnant magnetization (Mᵣ), saturation magnetization (Mₛ), coercive
field (H_{c}), calculated particle diameter (d) and relative permeability (μ)
are given as a function for all composition and treatment conditions.

| | Ms | Ms | Hc | Relative | Mr | | D1 | D2 | D3 |
|---|---|---|---|---|---|---|---|---|---|
| Sample | (emu/g) | (emu/mole) | (Oe) | Permeability | (emu/g) | Mr/Ms | (nm) | (nm) | (nm) |
| 6N5 | 57 | 10119.80964 | 86.1 | 100.0029 | 4.29 | 0.075 | 16.6 | 33.8 | 3.75 |
| 6N6 | 144 | 25565.83488 | 147.9 | 345.173 | 14.61 | 0.101 | 28.8 | NA | 2.46 |
| 6N7 | 149 | 26453.53748 | 76.9 | 83.35756 | 5.07 | 0.034 | 33.3 | 64.7 | 2.2 |
| 6N8 | 159 | 28228.94268 | 31.4 | 120.4594 | 0.88 | 0.006 | NA | NA | 1.72 |
| 6O5 | 20 | 3550.8104 | 169.9 | 9.63756 | 1.31 | 0.066 | NA | NA | 4.29 |
| 6O8 | 31 | 5503.75612 | 1198.7 | 78.57071 | 13.56 | 0.437 | NA | NA | 3.74 |
| 8N5 | 52 | 9264.22432 | 33.1 | 106.5221 | 1.35 | 0.026 | NA | NA | 5.65 |
| 8N6 | 106 | 18884.76496 | 32.6 | 201.6807 | 5.12 | 0.048 | NA | NA | 3.92 |
| 8N7 | 134 | 23873.19344 | 129.8 | 110.8177 | 4.66 | 0.035 | NA | NA | 2.19 |
| 8N8 | 149 | 26545.56584 | 57.1 | 74.65895 | 3.7 | 0.025 | NA | NA | 2.15 |
| 8O5 | 25 | 4453.954 | 24.6 | 278.9748 | 0.28 | 0.011 | NA | NA | 4.2 |
| 8O8 | 72 | 12827.38752 | 1082.9 | 116.0718 | 28.68 | 0.398 | NA | NA | 1.8 |
| 10N5 | 54 | 9653.8932 | 14.5 | 171.7874 | 1.1 | 0.02 | NA | NA | 3.9 |
| 10N6 | 80 | 14302.064 | 130.9 | 73.54557 | 5.87 | 0.073 | NA | NA | 2.49 |
| 10N7 | 120 | 21453.096 | 149 | 311.0598 | 7.07 | 0.059 | NA | NA | 1.94 |
| 10N8 | 132 | 23598.4056 | 57.9 | 332.5066 | 4.5 | 0.034 | NA | NA | 1.97 |
| 10O5 | 20 | 3575.516 | 4 | 28.12625 | 0.03 | 0.002 | NA | NA | 4.31 |
| 10O8 | 27 | 4826.9466 | 1198.3 | 36.65985 | 11.82 | 0.438 | NA | NA | 2.84 |

d¹ - TEM value, d² - Scherrer value, d³ - Langevin based calculation.

We claim:

1. Superparamagnetic transition metal iron oxygen nanoparticles having a saturation magnetization of at least about 100 emu/g;
wherein the transition metal comprises cobalt, manganese, chromium and/or nickel.

2. The nanoparticles of claim 1 wherein said nanoparticles have a coercivity (H_{c}) of no more than about 75 Oe.

3. The nanoparticles of claim 1 formed from AₓFe₃₋ₓO₄ and comprising zero valent metal clusters; wherein x has a value of 0.4 to 1.0 and A is a transition metal.

4. Transition metal iron oxygen nanoparticles formed by a process which comprises:
a) forming AₓFe₃₋ₓO₄ nanoparticles;
b) heating the AₓFe₃₋ₓO₄ nanoparticles in an oven at about 450° C. to 850° C.;
wherein A is selected from the group consisting of cobalt, manganese, chromium, nickel, iron and mixtures thereof.

5. The nanoparticles of claim 4 wherein x has a value of 0.4 to 1.0.

6. The nanoparticles of claim 4 wherein said nanoparticles are superparamagnetic.

7. The nanoparticles of claim 6 wherein the “A” element is selected from the group consisting of chromium, manganese, cobalt, nickel or a combination thereof.

8. The nanoparticles of claim 4 wherein the forming operation includes precipitating particles from an aqueous solution which includes iron nitrate hydrate, transition metal nitrate hydrate and sodium dodecylsulfate.

9. The nanoparticles of claim 4 wherein the forming operation includes forming AₓFe₃₋ₓO₄ nanoparticles via micellular synthesis.

10. The nanoparticles of claim 4 wherein the heating operation includes heating the AₓFe₃₋ₓO₄ particles in an oven at a temperature of at least about 550° C. for at least about one hour.

11. The nanoparticles of claim 4 wherein the heating operation includes heating the AₓFe₃₋ₓO₄ particles under a nitrogen atmosphere.

12. The nanoparticles of claim 11 wherein x has a value of at least about 0.7.

13. The nanoparticles of claim 11 wherein the heating operation includes heating the AₓFe₃₋ₓO₄ particles in an oven at a temperature of about 750° C. to 850° C.

14. Superparamagnetic transition metal iron oxygen nanoparticles having a saturation magnetization of at least about 50 emu/g and a coercivity (H_{c}) of no more than about 75 Oe.

15. The nanoparticles of claim 14 wherein the nanoparticles comprise cobalt, manganese, chromium, nickel or a combination thereof.

16. The nanoparticles of claim 14 comprising AₓFe₃₋ₓO₄ particles; wherein x has a value of 0.4 to 1.0 and A is a transition metal.

17. The nanoparticles of claim 14 having a saturation magnetization of at least about 100 emu/g.

18. The nanoparticles of claim 14 having a coercivity (H_{c}) of no more than about 55 Oe.

19. The nanoparticles of claim 14 having a coercivity (H_{c}) of no more than about 10 Oe.
